(19) United States
(12) Patent Application Publication
(10) Pub. No.: US 2021/0170344 A1
(43) Pub. Date: Jun. 10, 2021

(54) GRAPHENE STRUCTURE BASED ON ENHANCING HEAT TRANSFER EFFECT AND IMPROVING SEAWATER DESALINATION EFFICIENCY

(71) Applicants: Hong Cui, Hanzhong (CN); Weizhi Tian, Hanzhong (CN); Ying Zhang, Hanzhong (CN)

(72) Inventors: Hong Cui, Hanzhong (CN); Weizhi Tian, Hanzhong (CN); Ying Zhang, Hanzhong (CN)

(21) Appl. No.: 16/747,568

(22) Filed: Jan. 21, 2020

(30) Foreign Application Priority Data
Dec. 10, 2019 (CN) 201911259548.7

(51) Int. Cl. B01D 71/02; B01D 61/02; C02F 1/44; B01D 69/02; C01B 32/182; C02F 103/08

(52) U.S. Cl. CPC B01D 71/021; B01D 61/025; C02F 1/441; B01D 69/02; C01B 32/182; B01D 2325/02; C01B 2204/24; C02F 2103/08; C01B 2204/02; C01P 2002/78; B01D 2325/04; C01P 2006/16; C01B 2204/22

(57) ABSTRACT

The invention relates to the technical field of seawater desalination, in particular to a graphene structure based on enhancing heat transfer effect and improving seawater desalination efficiency, comprising a porous sheet and a single-layer graphene adhered to the porous sheet, wherein the pore diameter of the porous sheet is 0-2000 nm. The graphene structure of the invention has higher efficiency when it is used for seawater desalination by enhancing heat transfer effect and increasing the loading capacity of the graphene structure. The invention reduces the engineering cost and operating cost of seawater desalination.

### BACKGROUND OF THE INVENTION

### 1. Field of the Invention

The invention relates to the technical field of seawater desalination, in particular to a graphene structure based on enhancing heat transfer effect and improving seawater desalination efficiency.

### 2. Description of the Related Art

Seawater desalination refers to the use of seawater desalination to produce fresh water. It is an open source incremental technology to achieve the utilization of water resources, which can increase the total amount of fresh water without being affected by time, space and climate, and can ensure stable water supply for coastal residents' drinking water and industrial boiler make-up water.

The process of obtaining fresh water from seawater is called seawater desalination. The seawater desalination methods currently used include seawater freezing method, electrodialysis method, distillation method, reverse osmosis method, and ammonium carbonate ion exchange method; currently, the application of reverse osmosis membrane method and distillation method is the mainstream in the market.

The reverse osmosis method, also commonly called the ultrafiltration method, is a membrane separation and desalination method that was only adopted in 1953. This method uses a semi-permeable membrane that allows only solvents to pass through and solutes to separate seawater from fresh water. Under normal circumstances, fresh water diffuses to the seawater side through a semi-permeable membrane, so that the liquid level on the seawater side gradually rises until it stops at a certain height; this process is infiltration. At this time, the static pressure of the water column above the seawater side is called osmotic pressure.

If an external pressure greater than the osmotic pressure of seawater is applied to the seawater side, the pure water in the seawater will reverse osmosis into the fresh water. The greatest advantage of the reverse osmosis method is energy saving, whose energy consumption is only ½ of the electrodialysis method and 1/40 of the distillation method. Therefore, from 1974, developed countries such as the United States and Japan successively shifted their development focus to the reverse osmosis method.

Reverse osmosis seawater desalination technology has developed rapidly. The main development trends are to reduce the operating pressure of reverse osmosis membranes, improve the recovery rate of the reverse osmosis system, strengthen the cheap and efficient pretreatment technology, and enhance the system's anti-pollution capability.

However, the engineering cost and operating cost of conventional reverse osmosis seawater desalination technology are still very high, which greatly limits the promotion of seawater desalination technology.

### SUMMARY OF THE INVENTION

The objective of the invention is to provide a graphene structure based on enhancing heat transfer effect and improving seawater desalination efficiency, so as to reduce the engineering cost and operating cost of seawater desalination.

In order to achieve the objective above, the basic scheme of the invention is to provide a graphene structure based on enhancing heat transfer effect and improving seawater desalination efficiency, comprising a porous sheet and a single-layer graphene adhered to the porous sheet, wherein the pore diameter of the porous sheet is 0-2000 nm.

Further, the pore diameter of the porous sheet is 30-2000 nm.

Further, the porous sheet is a porous silicon carbide sheet.

Further, the thickness of the porous silicon carbide sheet does not exceed 45 μm.

Further, the graphene structure has a sheet resistance of not more than 90 ohm/sq.

Further, the thickness of the porous silicon carbide is 20-45 μm.

Further, the graphene structure has a sheet resistance of 30-90 ohm/sq.

Further, the single-layer graphene has a close-packed and chemically bonded parallel graphene plane, and the graphene plane has a graphene plane spacing of 0.355-0.385 nm.

Further, the graphene plane has a graphene plane spacing of 0.36-0.38 nm.

Compared with the prior art, the invention has the advantageous effects as follows:

(1) The use of silicon carbide as the bottom layer can improve the dispersibility and affinity of graphene, and between each graphene is the silicon carbide and they are in contact with each other, so a graphene structure with excellent thermal conductivity and electrical conductivity can be obtained. Therefore, the base material of the graphene heat transfer structure of the invention can transfer the heat received from the heat source to the graphene structure in a heat transfer manner, and escape from the graphene structure to the outside through heat conduction or heat radiation, thereby achieving the effect of enhancing heat transfer effect.

(2) The existing membrane desalinates seawater by reverse osmosis. This process is to apply pressure to one side of the membrane containing brine to push pure water through the membrane while preventing the passage of salt and other molecules. Many commercial membranes desalinate seawater at an applied pressure of about 50 to 80 bar, above which they tend to become dense or impaired. The membrane under the graphene structure of the invention can withstand a higher pressure of 100 bar or higher, which can recover more fresh water and make the seawater more effectively desalinated. High-pressure membranes are also capable of purifying very salty water, such as desalted residual brine, which is often too thick to pass through pure water.

(3) The graphene structure of the invention has higher efficiency when it is used for seawater desalination by enhancing heat transfer effect and increasing the loading capacity of the graphene structure.

### DETAILED DESCRIPTION OF THE PREFERRED EMBODIMENTS

Reference will now be made in detail to embodiments, examples of which are shown hereinafter:

when an element such as a layer, film, region, or substrate is referred to as being “on” another element, it can be directly on the other element or intervening elements may also be present. In contrast, when an element is referred to as being “directly on” another element, there are no intervening elements present.

Although the terms “first”, “second”, etc. may be used herein to describe various elements, components, regions, layers and/or sections, however, these elements, components, regions, layers and/or sections should not be limited by these terms. These terms are only used to distinguish one element, component, region, layer or section from another element, component, region, layer or section. Therefore, a first element, component, region, layer, or section described below can be termed a second element, component, region, layer, or section without departing from the principle of the embodiments.

For ease of description, spatially relative terms such as “below”, “beneath”, “above”, and the like may be used to describe the relationship between one element or feature and another element or feature shown in the drawings. Spatially relative terms are intended to summarize the different orientations of the device in use or operation in addition to the orientations shown in the drawings. For example, if the device in the drawings is turned over, elements described as “below” or “beneath” other elements or features would then be “above” the other elements or features. Therefore, the exemplary term “below” can cover both above and below orientations. The device can take other orientations (rotated 90 degrees or at other orientations), and the spatial relative descriptors used here are explained accordingly.

The terms used herein are for the purpose of describing particular embodiments only and are not intended to limit the exemplary embodiments. As used herein, the singular forms “a” and “the” are intended to include the plural forms as well, unless the context clearly indicates otherwise. It should be further understood that the terms “including” and/or “comprising” specify the presence of said features, integers, steps, operations, elements and/or components when used in this specification, but do not exclude the presence or existence of one or more other features, integers, steps, operations, elements and/or components.

Unless otherwise defined, all terms (including technical and scientific terms) used herein have the same meaning as commonly understood by those of ordinary skill in the art to which exemplary embodiments belong. It should be further understood that terms such as those defined in a general dictionary, unless explicitly defined here, should be interpreted as having meanings consistent with their meaning in the context of the relevant field, and should not be interpreted as idealized or excessive meaning.

In this specification, the term “graphene” refers to a polycyclic aromatic molecule formed by a two-dimensional (2D) carbon hexagonal plane, that is, a 2D thin film with a honeycomb structure formed by covalent bonds of a plurality of carbon atoms. Carbon atoms connected to each other through covalent bonds form a six-membered ring as a basic repeating unit. However, the structure of the carbon atom may also include a five-membered ring and/or a seven-membered ring. Therefore, graphene appears to be a monolayer of covalently bonded (sp2 hybrid) carbon atoms. Graphene may have various structures that vary depending on a five-membered ring or a seven-membered ring included in graphene. Graphene may be formed as a monoatomic layer.

The basic scheme of the invention is to provide a graphene structure based on enhancing heat transfer effect and improving seawater desalination efficiency, comprising a porous sheet and a single-layer graphene adhered to the porous sheet, wherein the pore diameter of the porous sheet is 0-2000 nm; graphene placed on pores that are 200 nanometers wide or smaller can withstand a pressure of 100 bar, which is almost twice the pressure commonly found in desalination. Moreover, the research process found that as the size of the underlying pores decreases, the number of microfilms that remain intact increases.

In at least one embodiment, the pore diameter of the porous sheet is 30-2000 nm.

In at least one embodiment, the porous sheet is a porous silicon carbide sheet.

In at least one embodiment, the thickness of the porous silicon carbide sheet does not exceed 45 μm.

In at least one embodiment, the graphene structure has a sheet resistance of not more than 90 ohm/sq.

In at least one embodiment, the thickness of the porous silicon carbide is 20-45 μm.

In at least one embodiment, the graphene structure has a sheet resistance of 30-90 ohm/sq.

In at least one embodiment, the single-layer graphene has a close-packed and chemically bonded parallel graphene plane, and the graphene plane has a graphene plane spacing of 0.355-0.385 nm.

In at least one embodiment, the single-layer graphene has a close-packed and chemically bonded parallel graphene plane, and the graphene plane has a graphene plane spacing of 0.36-0.38 nm.

Compared with the prior art, the invention has the advantageous effects as follows:

(1) The use of silicon carbide as the bottom layer can improve the dispersibility and affinity of graphene, and between each graphene is the silicon carbide and they are in contact with each other, so a graphene structure with excellent thermal conductivity and electrical conductivity can be obtained. Therefore, the base material of the graphene heat transfer structure of the invention can transfer the heat received from the heat source to the graphene structure in a heat transfer manner, and escape from the graphene structure to the outside through heat conduction or heat radiation, thereby achieving the effect of enhancing heat transfer effect.

(2) The existing membrane desalinates seawater by reverse osmosis. This process is to apply pressure to one side of the membrane containing brine to push pure water through the membrane while preventing the passage of salt and other molecules. Many commercial membranes desalinate seawater at an applied pressure of about 50 to 80 bar, above which they tend to become dense or impaired. The membrane under the graphene structure of the invention can withstand a higher pressure of 100 bar or higher, which can recover more fresh water and make the seawater more effectively desalinated. High-pressure membranes are also capable of purifying very salty water, such as desalted residual brine, which is often too thick to pass through pure water.

(3) The graphene structure of the invention has higher efficiency when it is used for seawater desalination by enhancing heat transfer effect and increasing the loading capacity of the graphene structure.

What have been described above are only embodiments of the invention, and common sense such as the specific structure and characteristics known in the scheme are not described here too much. It should be noted that modifications and improvements made by those skilled in the art without departing from the structure of the invention shall fall within the protection scope of the invention, and these will not affect the effect of the implementation of the invention and the utility of the patent. The protection scope of the application shall be based on the content of the claims, and the specific implementation manners in the description may be used to interpret the content of the claims.

1. A graphene structure based on enhancing heat transfer effect and improving seawater desalination efficiency, comprising a porous sheet and a single-layer graphene adhered to the porous sheet, wherein the pore diameter of the porous sheet is 0-2000 nm.

2. The graphene structure based on enhancing heat transfer effect and improving seawater desalination efficiency according to claim 1, wherein the pore diameter of the porous sheet is 30-2000 nm.

3. The graphene structure based on enhancing heat transfer effect and improving seawater desalination efficiency according to claim 1, wherein the porous sheet is a porous silicon carbide sheet.

4. The graphene structure based on enhancing heat transfer effect and improving seawater desalination efficiency according to claim 3, wherein the thickness of the porous silicon carbide sheet does not exceed 45 μm.

5. The graphene structure based on enhancing heat transfer effect and improving seawater desalination efficiency according to claim 4, wherein the graphene structure has a sheet resistance of not more than 90 ohm/sq.

6. The graphene structure based on enhancing heat transfer effect and improving seawater desalination efficiency according to claim 3, wherein the thickness of the porous silicon carbide is 20-45 μm.

7. The graphene structure based on enhancing heat transfer effect and improving seawater desalination efficiency according to claim 5, wherein the graphene structure has a sheet resistance of 30-90 ohm/sq.

8. The graphene structure based on enhancing heat transfer effect and improving seawater desalination efficiency according to claim 1, wherein the single-layer graphene has a close-packed and chemically bonded parallel graphene plane, and the graphene plane has a graphene plane spacing of 0.355-0.385 nm.

9. The graphene structure based on enhancing heat transfer effect and improving seawater desalination efficiency according to claim 8, wherein the graphene plane has a graphene plane spacing of 0.36-0.38 nm.
